(19) United States
(12) Patent Application Publication
(10) Pub. No.: US 2006/0200291 A1
(43) Pub. Date: Sep. 7, 2006

(54) Tactile electronic steering system

(76) Inventor: Anthony J. Wroblewski, Youngstown, OH (US)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 11/370,796

(22) Filed: Mar. 7, 2006

Related U.S. Application Data
(60) Provisional application No. 60/659,211, filed on Mar. 7, 2005.

(51) Int. Cl. B62D 6/00

(52) U.S. Cl. 701/41

(57) ABSTRACT

A steering control system adjusts steering gain and position of the vehicle wheels based on a rate of change of the steering wheel. The steering control system provides a passive feedback control signal to a passive tactile feedback device. The steering control system provides electronic steering control that is consistent with the feel of a standard hydrostatic steering system.

### RELATED APPLICATION DATA

This application claims benefit of U.S. Provisional Application No. 60/659,211, filed Mar. 7, 2005, which is incorporated herein by reference in its entirety.

### FIELD OF THE INVENTION

The present invention relates to steering control systems, and, particularly, to an electronic steering control system for slow-moving, off-highway vehicles.

### BACKGROUND OF THE INVENTION

Vehicles, such as slow-moving, off-highway vehicles, traditionally have been turned or steered by a direct mechanical link between the steering wheel and the steered wheels. With such systems, the operator turns a steering wheel or manipulates a steering joystick to request that a steering assembly turn the vehicle wheels. Feedback of the torque or other resistance encountered by the steering system as the wheels are turned is provided to the operator through the mechanical and hydraulic linkage. This feedback can provide the operator with a sense of the road conditions, such as the traction of the vehicle wheels with the road surface. In addition, this feedback provides the operator with some sense of the condition of the steering system as a whole.

More recently, it has been proposed that direct mechanical and hydraulic linkages be replaced by electronic steering systems (sometimes referred to as steer-by-wire systems). In a steer-by-wire system, a position encoder monitors the amount of turning of a steering wheel or other steering device. The position encoder translates the amount of turning of the wheel into the desired amount of turning of the vehicle wheels. An electric signal is sent to the steering system, and the vehicle wheels are turned in response to the signals.

Electronic steering systems are viewed as having great potential in that they eliminate a number of required mechanical and/or hydraulic connections and components. However, with these systems, the operator is not provided with any feedback regarding the driving and/or road conditions. In fact, in most electronic steering systems, the steering system is able to “freewheel” or spin with absolutely no feedback. Not only would some drivers find this undesirable, it may also be unsafe in some circumstances. In contrast, the feedback typically provided by hydraulic linkages does provide the operator with an appreciation of the traction and road conditions that the vehicle is experiencing on a particular surface, and thus, allows the driver to adjust driving to the given surface conditions.

### SUMMARY OF THE INVENTION

The present invention provides a steering system that provides adjustable steering gain. The steering system may further provide adjustable steering effort and adjustable tactile feedback based on steering pressure and steering actuator position. The steering system provides electronic steering control in connection with passive feedback to the operator that is consistent with the feel of a standard hydraulic steering system.

Thus, a vehicle steering system according to one aspect of the invention is characterized by a steering device, a position sensor that senses the position of the steering device, and a steering controller in operative communication with the steering device and the position sensor. The steering controller determines a rate of change of the position of the steering device, and generates a steering command signal for moving wheels of the vehicle in a desired direction at a desired speed based on the determined rate of change.

According to another aspect of the invention, there is provided a method of controlling steering in a slow-moving off-highway vehicle. The method comprises detecting a position of a steering device, determining a rate of change of the position of the steering device, and, based on the determined rate of change, generating a steering command signal for moving wheels of the vehicle in a desired direction at a desired speed.

According to another aspect of the invention a steering control system includes a steering controller in operative communication with a steering device and a position sensor, which senses the position of the steering device. The steering controller determines a rate of change of the position of the steering device, and generates a steering command signal for moving wheels of a vehicle in a desired direction at a desired speed based on the determined rate of change.

The foregoing and other features of the invention are hereinafter fully described and particularly pointed out in the claims, the following description and annexed drawings setting forth in detail a certain illustrative embodiment of the invention, this embodiment being indicative, however, of but one of the various ways in which the principles of the invention may be employed.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic diagram of a steering control system incorporating the present invention;

FIG. 2 is a flow chart illustrating a method of controlling a steering system in accordance with the present invention;

FIG. 3 is a schematic diagram of a conventional hydraulic steering system; and

FIG. 4 is a schematic diagram of a hydraulic steering system incorporating aspects of the present invention.

### DETAILED DESCRIPTION

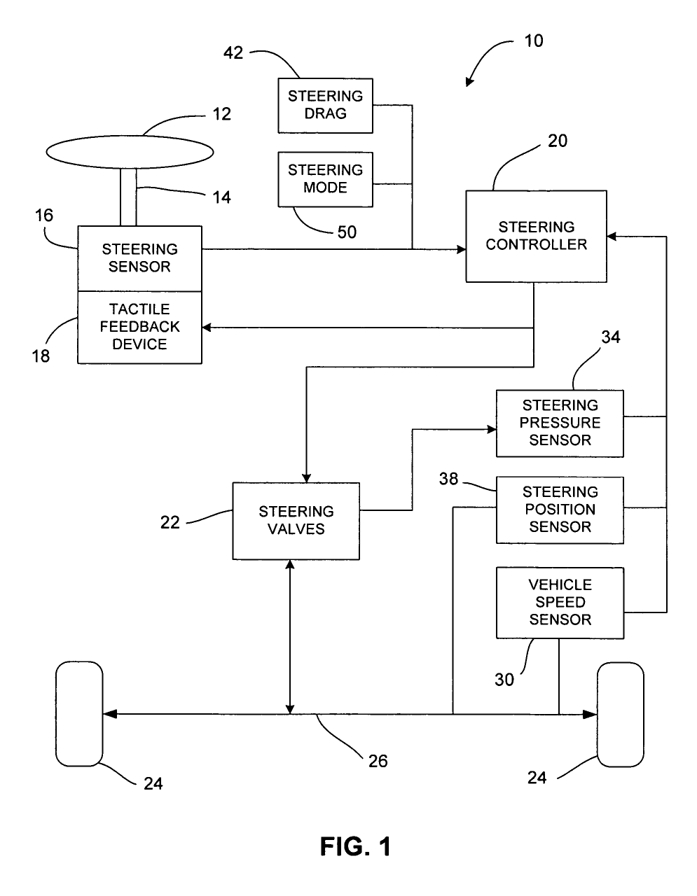

FIG. 1 presents a schematic diagram of a steering control system 10. The steering system 10 includes a steering device 12, e.g., a steering wheel or a steering joystick, that turn a steering column 14. A position sensor 16 monitors the amount of turning or movement of the steering column 14 and communicates the amount to a steering controller 20. As is discussed more fully below, the steering controller controls the steering system based on a rate of change of the position of the steering device 12. In addition, the steering controller 20 generates a control signal to provide passive tactile feedback to an operator through the steering device 12 based upon one or more parameters as will be set forth herein below in more detail.

In general, the steering controller 20 provides control signals to the vehicle steering system, including the steering valves 22, which, in turn, cause the various components, e.g., the cylinders, of the steering system to move the vehicle's wheels 24 in a desired direction. The basic operation of hydraulic steering is known, therefore, it will not be described in great detail. Element 26 is intended to represent generally hydraulic steering components, e.g., valves, cylinders and axles. It will be appreciated that the steering control system described herein is not limited to a particular hydraulic steering system, and can be employed with a variety of hydraulic steering systems.

The steering device 12 is used to indicate to the steering controller 20 a desire to move the vehicle's wheels 24 in a desired direction at a desired speed. This is accomplished by measuring the rate of change of the steering wheel 12 using the position sensor 16. A rate of change of zero would equal zero when the steering wheel 12 is in a stationary position and increases as the operator begins to rotate it. The faster the operator turns the steering wheel 12, the higher the command signal is for a desired motion in the vehicles wheels 24.

This rate of change command is used by the steering controller 20 to calculate a desired offset position from the current position of the vehicle's wheels 24. The steering controller 20 also looks at the current cylinder position both front and rear. In addition, the steering controller determines what steering mode the operator has selected, e.g., 2 wheel, 4 wheel or 4 wheel crab. The steering controller 20, e.g., by means of a proportional integral derivative (PID) loop, generates a command signal for the steering valve outputs 22. These command signals are used on the electronic proportional pilot control end caps on the directional control valve to shift spool position to desired position to provide hydraulic power to the vehicle wheels 24, e.g., via steering cylinders. As is described more fully below, vehicle ground speed also is constantly monitored. Ground speed is used as a limiting object in the respect to how fast the operator is permitted to turn the vehicle wheels while the vehicle is traveling at higher ground speeds. This provides safer steering situations.

The steering control system includes a tactile feedback device 18 that provides tactile feedback, e.g. in the form of turning resistance, to the steering wheel 12 via the steering column 14. As is explained more fully below, the tactile feedback device 18 receives a control signal from the steering controller 20 in response to a number of parameters including, but not limited to, rate of change of the position of the steering device 12, vehicle ground speed, proximity to the end of cylinder stroke, steering system pressure, operator-adjustable steering drag and the like.

In a preferred embodiment, the steering feedback device 18 includes a steering brake, such as a rheological fluid brake unit. Rheological brake systems include rheological fluid, which is a free-flowing liquid that when exposed to a magnetic field or current, can transform from a fluid state into a near-solid state in milliseconds. Just as quickly, the fluid can be returned to its liquid state with the removal of the field or current. Typically, the degree of change in a Theological fluid is proportional to the magnitude of the applied magnetic field or current. One suitable rheological steering brake can be provided by LORD corporation. Of course, it is to be appreciated, that other types of steering brakes and steering tactile feedback devices can be employed without departing from the scope of the present invention.

In addition to providing a steering command signal to the steering valves 22 based on the rate of change of the position of the steering wheel, the steering controller 20 computes or otherwise provides a control signal to the tactile feedback device 18 based on one or more signals or parameters from a plurality of devices within the steering control system.

For example, the steering system may include a speed sensor 30, which measures the ground speed, and provides a signal to the steering controller 20 that is indicative of the speed of the vehicle wheels. In an exemplary embodiment, the steering controller may provide an increase tactile feedback signal to the tactile feedback device 18 when the speed sensor 30 senses a higher vehicle speed. In this embodiment, the tactile feedback device 18 would provide tactile resistance to the steering wheel 12, e.g., making it more difficult for an operator to turn the steering wheel 12, when the vehicle is sensed to be traveling at a higher speed. It will be appreciated that this type of tactile feedback may improve vehicle safety by making it more difficult for an operator to rapidly change the vehicle wheel position while the vehicle is moving at a relatively higher speed.

The steering system also may include a steering system pressure sensor 34 that is operable to capture steering system pressure by tapping into a directional control valve. In one embodiment, a port is machined into the load sense cavity between the front and rear steering sections of a valve bank. This allows the system to measure the load sense signal from both sections. In this embodiment, the highest signal is sent back through the load sense channel in the valve, thereby providing the highest load demand. The pressure sensor 34 captures this data and provides the current steering system pressure to the steering controller 20. It will be appreciated that pressure rises in the cylinder as the vehicle wheels overcome friction and obstacle forces.

By taking advantage of this natural hydraulic steering characteristic, the steering control system is capable of translating steering pressure into tactile feedback, e.g. via brake output, e.g., resistance or drag, to the steering wheel 12. In a preferred embodiment, the rheological brake is energized and de-energized as commanded by the steering controller 20 based on the steering pressure curve. Therefore, when steering pressures are lower, the drag or resistance on the steering wheel is lower. As the pressure increases, the operator will feel the increase drag or resistance while rotating the steering wheel until it either reaches a hard stop or overcomes a road obstacle. It will be appreciated that this direct link back to actual steering position and ground terrain condition provides the operator with a more controlled feeling while operating the vehicle.

Steering position sensor(s) 38 provide(s) the cylinder position, e.g., absolute position, and, therefore, the position of the vehicle wheels 24, to the steering controller 20, thereby providing information regarding the end of cylinder stroke. In a preferred embodiment, the steering cylinder(s) are capable of providing information about their absolute position. Alternatively, a separate cylinder position sensor may provide information to the steering controller 20 regarding the absolute position of the vehicle wheels. In a preferred embodiment, in response to information regarding cylinder position 38, the steering controller 20 will provide a command signal to the tactile feedback device, for example a command signal to energize the rheological steering brake, causing the steering wheel to lock up in an end of stroke or “lock-to-lock” position. Preferably, the steering controller 20 will command the tactile feedback device 18 to ramp up steering resistance or drag before the end of the steering cylinder stroke, e.g., at about one to two inches before the end of the steering cylinder stroke. This lock state can be disengaged when the steering controller sees a change in steering wheel torque from steering brake/position sensor combination.

As is discussed above, the speed at which the steering wheel 12 is being turned by an operator already is being measured for command purposes to provide a steering command signal to the steering valves for the vehicle wheels. In one embodiment, the steering controller 20 also takes this steering wheel speed value and compares it to actual valve output. Once valve output has reached 100%, the steering feedback mechanism, e.g. the steering brake resistance or drag can be increased to assist the operator in keeping a controlled state. Therefore, once input saturation has been reached from high-speed steering, the steering brake will apply slightly more resistance or drag to provide the operator with the sensation that the steering is going as fast as it can travel.

The steering system also includes an operator-adjustable steering drag selector 42. Using the steering drag selector 42, the operator is provided with the capability to adjust the normal drag from the steering controller 20 to the steering feedback mechanism 18. For example, the operator can set the minimum drag or resistance to 0% (actual drag is the friction of a mechanical steering column) up to 100% (although it may be very difficult to steer at the highest setting). The operator is provided with the ability to tailor how much effort is required to turn the steering wheel with, e.g., the touch of a button or the adjustment of a switch or a lever. At the 0% or lowest setting, the operator would feel a very free-moving steering wheel until he/she reached a condition under which the drag or resistance would increase, e.g., end of stroke pressure build-up and the like. If an operator desires more drag he/she could simply increase the percentage up to a desired feel.

In a preferred embodiment, the steering system also includes a steering mode selector switch 50. The steering mode selector switch 50 provides a way for the operator to communicate a desired steering mode to the steering controller. The steering controller 20 is operable to calculate a desired wheel position for front and rear steering cylinders based on the steering mode selected by the operator. This functionality in connection with the steering control system described herein, eliminates the need to realign the front and rear vehicle wheels on steering mode changes. The steering controller compensates for the change and will move the vehicle wheels to a desired position upon receiving a steering command from the steering wheel. It also will return the rear wheels to a zero, e.g., straight, position when switching out of one of the four wheel modes. It will be appreciated that an operator can use the steering mode selector switch 50 to switch between the following modes: a two wheel mode in which the operator makes use of typical two wheel, e.g., front or rear steering; a four wheel mode that makes the wheels between front and rear turn in opposite directions to provide a tight turning radius; and a four wheel crab steering mode that syncs the front and rear wheels so that the operator can move the vehicle side to side. While the above-mentioned three steering modes are known, the steering control system described herein allows for on-the-fly switching between the steering modes and, as mentioned above, eliminates the need to realign the front and rear vehicle wheels on mode changes.

A person having ordinary skill in the art of programming and control system programming for hydraulic control systems, in view of the description provided herein would be able to program a steering controller to operate and carry out the functions described herein with respect to the rate of change steering control and the tactile feedback control signal. Accordingly, details as to the specific programming code have been omitted here for the sake of brevity. Also, while the rate of change steering control and the tactile feedback control signal are provided via a processor and application program in a device memory in accordance with aspects of the invention, such function could also be carried out via dedicated hardware, firmware, software or combinations thereof without departing from the scope of the present invention.

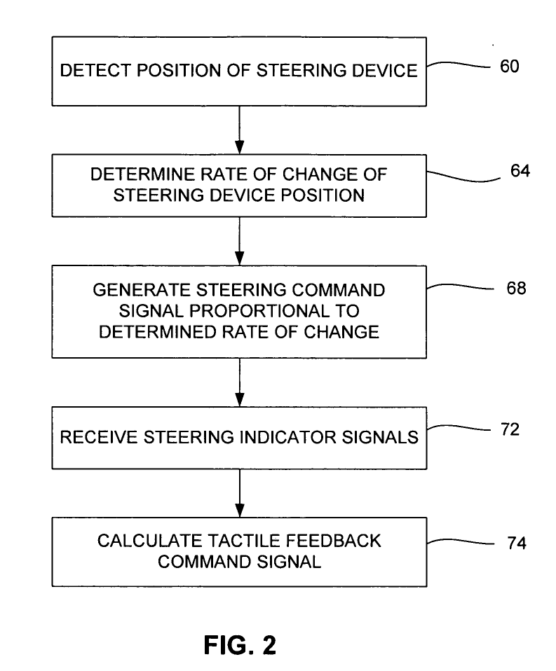

With reference now to FIG. 2, a method of controlling the steering of a vehicle, e.g., a slow-moving, off-highway vehicle, is provided. It will be appreciated that many of the details associated with the method illustrated in FIG. 2 have been discussed above in greater detail. Therefore, that detail will not be repeated here. At step 60, the position of the steering device is detected. As described above, detection of the steering position and changes thereof can be accomplished using a suitable position encoder. At step 64, the rate of change of the steering device position is determined. This rate of change or speed of the steering device can be determined by the position sensor or by the steering controller in response to signals received from the position sensor. At step 68, a steering command is generated that is proportional to the determined rate of change of the steering device. Once the steering command signal is generated or otherwise calculated, the steering controller may examine the steering mode switch input to determine the vehicle's steering mode, and apply the command signals to both front and rear valve steering sections to cause the steering actuator to move as commanded by the vehicle operator.

At step 72, a plurality of vehicle indicator signals are received. As is described above, these can include, but are not limited to, vehicle wheel speed, cylinder position, steering pressure, operator-selected drag coefficients, and the like. In response to these received vehicle indicator signals, one or more tactile feedback control signals are generated at step 76. As is described more fully above, the tactile feedback control signals can be communicated to a suitable tactile feedback device, such as a Theological brake, to provide additional resistance or drag to a steering wheel, which will be perceived by a vehicle operator. In one embodiment, the steering controller 20 will compute a composite feedback signal at selected time intervals, e.g., a composite feedback signal that takes into account each of the aforementioned vehicle conditions, e.g., steering pressure, cylinder position, vehicle wheel speed and operator-selected steering drag. Alternatively, the steering controller 20 will provide a number of discreet feedback control signals whenever a vehicle condition signal is received by the steering controller.

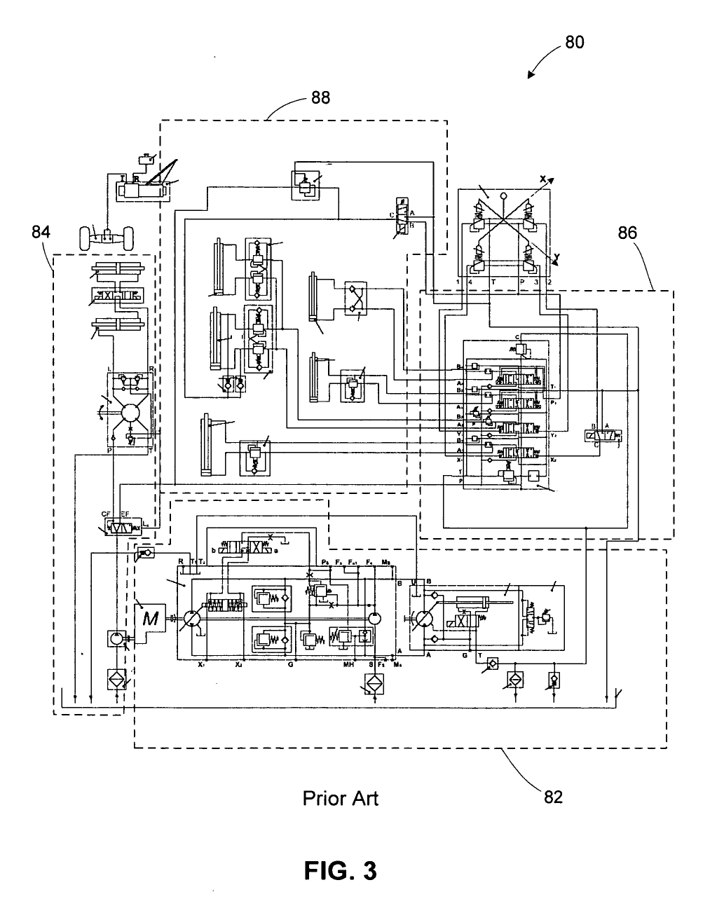

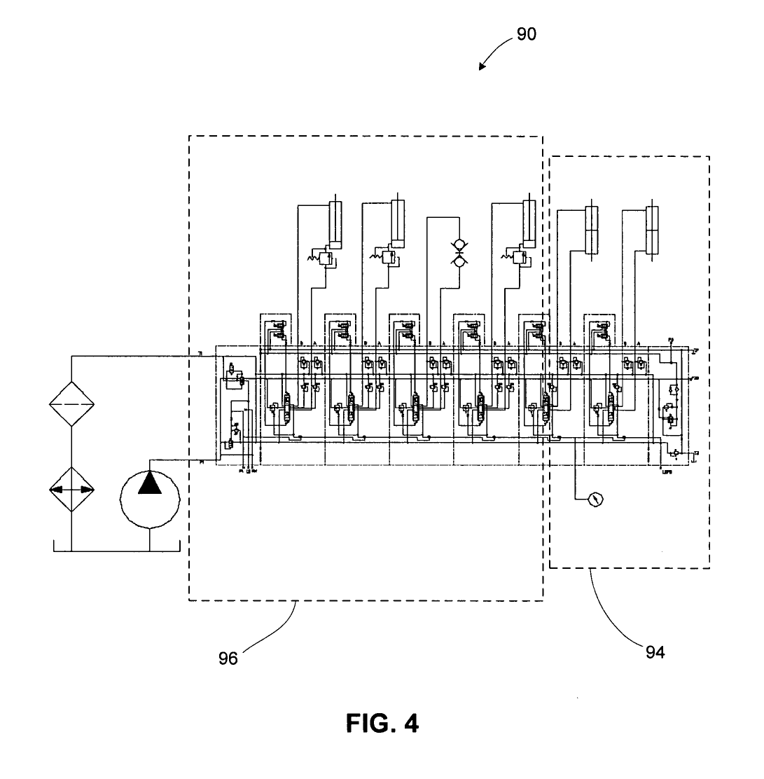

With reference now to FIG. 3 and FIG. 4, exemplary schematic diagrams of hydraulic steering systems are provided. FIG. 3 schematically depicts a conventional hydraulic steering system 80. The steering system 80 includes a hydrostatic drive portion 82, a hydraulic steering control portion 84, a directional control valve portion 86 and an implement actuator portion 88. In contrast, FIG. 4 schematically depicts an exemplary steering system 90 that is operable to be controlled by the electronic steering control system described herein. Artisans will appreciate that implementation of the electronic steering control system described herein eliminates the need for the hydraulic steering control portion 84 depicted in FIG. 3. This results in simplification of the overall steering system, and eliminates the need for hydraulic components in the cab of the vehicle. Artisans will appreciate that the simplified steering system 90 includes a hydrostatic drive portion (not shown), which is similar to element 82 depicted in FIG. 3. Steering system 90 includes the addition of the steering actuators 94 to the implement actuator bank 96, thereby resulting in a simplified steering system. Steering actuators 94 are controlled by the electronic steering control system described herein.

Although the invention has been shown and described with respect to certain illustrated embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiments of the invention.

What is claimed is:

1. A vehicle steering system comprising:
a steering device;
a position sensor that senses the position of the steering device; and
a steering controller in operative communication with the steering device and the position sensor, wherein the steering controller:
determines a rate of change of the position of the steering device; and
generates a steering command signal for moving wheels of the vehicle in a desired direction at a desired speed based on the determined rate of change.

2. A steering system according to claim 1, further comprising a tactile feedback device in operative contact with steering device.

3. A steering system according to claim 2, wherein the tactile feedback device is a Theological steering brake.

4. A steering system according to claim 2, wherein the tactile feedback device provides a drag to movement of the steering device in response to a feedback command signal from the steering controller.

5. A steering system according to claim 4, wherein the steering controller determines a feedback command signal based on the rate of change of the position of the steering device.

6. A steering system according to claim 5, wherein the steering controller provides a feedback command signal that increases drag in response to a rate of change above a predetermined threshold.

7. A steering system according to claim 4, further comprising a ground speed sensor, wherein the steering controller determines a feedback command signal based on vehicle speed sensed by the ground speed sensor.

8. A steering system according to claim 7, wherein the steering controller provides a feedback command signal that increases drag in response to an increased ground speed.

9. A steering system according to claim 4, further comprising a steering system pressure sensor, wherein the steering controller determines a feedback command signal based on steering system pressure sensed by the steering system pressure sensor.

10. A steering system according to claim 9, wherein the steering controller provides a feedback command signal that increases drag in response to an increased steering system pressure.

11. A steering system according to claim 4, further comprising a sensor for sensing vehicle wheel position, wherein the steering controller determines a feedback command signal based on the sensed by the sensor for sensing vehicle wheel position.

12. A steering system according to claim 11, wherein the steering controller provides a feedback command signal that increases drag in response to a vehicle wheel position indicative of end of stroke.

13. A steering system according to claim 4, further comprising an operator-adjustable steering drag selector, wherein the steering controller determines a feedback command signal based on the operator-selected steering drag.

14. A steering system according to claim 4, further comprising a steering mode selector that provides on-the-fly selection between steering modes.

15. A steering system according to claim 1, further comprising a hydraulic system that controls vehicle steering based on command signals received from the steering controller.

16. A method of controlling steering in a slow-moving off-highway vehicle, the method comprising:
detecting a position of a steering device;
determining a rate of change of the position of the steering device; and
based on the determined rate of change, generating a steering command signal for moving wheels of the vehicle in a desired direction at a desired speed.

17. A method according to claim 16, further comprising:
providing a feedback command signal to a passive tactile feedback device in communication with the steering device.

18. A method according to claim 16, wherein feedback command signal is provided in response to sensed ground speed, steering system pressure, vehicle wheel position and/or operator-selected steering drag.

19. A steering control system comprising:
a steering controller in operative communication with a steering device and a position sensor that senses the position of the steering device, wherein the steering controller:
determines a rate of change of the position of the steering device; and
generates a steering command signal for moving wheels of the vehicle in a desired direction at a desired speed based on the determined rate of change.

20. The steering control system according to claim 19, wherein the steering controller evaluates steering mode selection before generating the steering command signal.

21. The steering control system according to claim 19, further comprising a tactile feedback device in operative contact with steering device.
